(19) United States
(12) Patent Application Publication
(10) Pub. No.: US 2016/0274870 A1
(43) Pub. Date: Sep. 22, 2016

(54) DESIGN FRAMEWORK FOR AN IOT SYSTEM

(71) Applicant: Arrayent, Inc., Redwood City, CA (US)

(72) Inventor: Glenn Seidman, Woodside, CA (US)

(21) Appl. No.: 15/075,573

(22) Filed: Mar. 21, 2016

Related U.S. Application Data
(60) Provisional application No. 62/136,373, filed on Mar. 20, 2015.

(51) Int. Cl. G06F 9/44; G06F 17/27

(52) U.S. Cl. CPC G06F 8/31; G06F 17/2705

(57) ABSTRACT

A design framework for an Internet-of-Things (IoT) system uses a programming-language-neutral file that describes an embedded device that is a specific-purpose end node in the IoT system. A programming-language-specific file is generated from the programming-language-neutral file for a node in the IoT system. The programming-language-specific file is in a programming-language-dependent code and specifies a compilable-language program for a control application to be installed in a computer in the IoT system for communicating with and controlling the embedded device. In some embodiments, at least one of the programming-language-specific file is created for at least one of several types of nodes in the IoT system.

### CROSS-REFERENCE TO RELATED APPLICATIONS

This patent application claims the benefit of U.S. Provisional Patent No. 62/136,373 filed Mar. 20, 2015. The content of U.S. Provisional Patent No. 62/136,373 is incorporated herein by reference.

### BACKGROUND OF THE INVENTION

At the turn of the century, the now ubiquitous term “Internet-of-Things” (IoT) was already in use and generally referred to electronic things or devices that had a connection to the Internet (or other network), but which were not general-purpose computers. A connected future seemed to be just on the horizon, in which everyday devices could do more for us, collect information on how we used them, and use that information to become even more useful in the future. The whole world, some said, would don an electric skin comprised of millions of thermostats, pollution detectors, motion sensors, imaging systems, medical sensors, and a myriad of other devices. This global network would forge a brighter future from the petabytes of raw data it would generate every minute.

The IoT has indeed placed us on the verge of a revolution, akin to that brought about when the personal computer was linked to the Internet. However, the complete fruition of this revolution faces a set of challenges that are an order of magnitude more complex than those of the early days of the Internet. During the connected PC revolution, the operating paradigm of each connected device was the same—input was provided by a user operating a keyboard and a pointing device such as a mouse, while output was provided to monitors with standardized resolutions. Further, the hardware options for the connected devices of that prior revolution were likewise limited. The devices themselves were drawn from a limited set of standard options represented by the offerings of either IBM, Inc., or Apple, Inc., and the physical layer communication protocols for the devices were limited to hardwire Ethernet or, in some instances, Wi-Fi.

Designing for the IoT is far more complex than designing for the Internet of PCs for the obvious reason that there are just so many different things that need to be connected. Each connected device has the potential to exhibit a wholly distinct paradigm for its functionality, input, and output. For example, the manner in which a person interacts with a microwave bears almost nothing in common with the manner in which one interacts with a GPS tracking device or an automatic pool cleaner. Indeed, many connected devices do not receive direct input from a user at all, and instead respond to input from connected sensors or merely relay information provided by other devices. Furthermore, the IoT is rife with proprietary operating systems, various code bases, and wildly variant communication protocols. As just one example, the wireless physical layer protocols for IoT devices can include protocols as diverse as Wi-Fi, ZigBee, Z-Wave, and AC900.

Although the diversity of devices and protocols is enough on its own, the IoT offers an additional layer of complexity in that, to be a truly useful IoT solution, the system must be designed to offer an end-to-end experience from the device, through the Internet, to some form of web accessible portal. For a true end-to-end platform, software must, of course, be designed to instantiate the device's functionality and connectivity, but the design task also involves generating code for each link of the chain from the device to the web portal. This chain can involve a multitude of communication protocols and code bases on each of the nodes in the chain. To create an efficient system, each of these links must be optimized for the desired functionality of the connected device. Finally, even once such a system has been created, testing the system requires intimate knowledge not only of the goals of the overall system, but also intimate knowledge of how those goals interact with the numerous communication protocols, operating systems, and code bases on which that system is instantiated.

### SUMMARY OF THE INVENTION

Some embodiments of the present invention involve a method comprising: receiving, by a processor acting in combination with an electronic memory, a programming-language-neutral file that describes an embedded device that is a specific-purpose end node in an Internet-of-Things system; and generating, by the processor from the programming-language-neutral file, a programming-language-specific file for a node in the Internet-of-Things system, the programming-language-specific file being in a programming-language-dependent code and specifying a compilable-language program for a control application to be installed in a computer in the Internet-of-Things system for communicating with and controlling the embedded device.

Some embodiments of the present invention involve a method comprising: receiving, by a processor acting in combination with an electronic memory, a programming-language-neutral file that describes an embedded device that is a specific-purpose end node in an Internet-of-Things system; and converting, by the processor, the programming-language-neutral file into at least one programming-language-specific file for at least one node in the Internet-of-Things system, the at least one programming-language-specific file being in at least one programming-language-dependent code and specifying at least one compilable-language program for at least one purpose of: a) a server application to be installed in a server in the Internet-of-Things system for communicating with and controlling the embedded device through a multi-protocol network, b) a user device application to be installed in an access device for communicating with and controlling the embedded device through the multi-protocol network, c) an embedded application to be installed in the embedded device for controlling the embedded device and communicating through the multi-protocol network, d) a simulation application for performing a simulation to analyze performance of the embedded device, e) a verification application for testing the embedded device, and f) a gateway application to be installed in a gateway between the server and the embedded device.

Some embodiments of the present invention involve a non-transitory computer readable medium enabling a processor, acting in combination with an electronic memory, to execute a computer-implemented method, the computer-implemented method comprising: receiving a programming-language-neutral file that describes an embedded device that is a specific-purpose end node in an Internet-of-Things system; and converting the programming-language-neutral file into a programming-language-specific file for a node in the Internet-of-Things system, the programming-language-specific file being in a programming-language-dependent code and specifying a compilable-language program for a control application to be installed in a computer in the Internet-of-Things system for communicating with and controlling the embedded device.

In some embodiments, a second programming-language-specific file is generated specifying a second compilable-language program for an embedded application to be installed in the embedded device for controlling the embedded device and communicating with the computer. In some embodiments, the second programming-language-specific file represents a run time client library code for multiple user device applications to be installed in multiple access devices for communicating with and controlling the embedded device. In some embodiments, the programming-language-neutral file is parsed to identify a canonical representation of the embedded device, and the canonical representation is used to generate the programming-language-specific file.

In some embodiments, a set of primitives are temporarily generated in the electronic memory using a purpose adapter applied to the programming-language-neutral file, and the set of primitives are used to generate the programming-language-specific file.

### BRIEF DESCRIPTION OF THE DRAWINGS

FIG. 1 illustrates a block network diagram of an Internet of Things (IoT) platform that is in accordance with embodiments of the present invention.

FIG. 2 illustrates a conceptual diagram to show the benefits of an IoT design framework that is in accordance with embodiments of the present invention.

FIG. 3 illustrates a block flow diagram of a compiler architecture for an IoT system that is in accordance with embodiments of the present invention.

FIG. 4 illustrates a code block for a data type definition for a unified design language that is in accordance with embodiments of the present invention.

FIG. 5 illustrates a code block for a device face definition for a unified design language that is in accordance with embodiments of the present invention.

FIG. 6 illustrates a code block for a list of combination device face definitions for a unified design language that is in accordance with embodiments of the present invention.

FIG. 7 illustrates a code block for a library definition for a unified design language that is in accordance with embodiments of the present invention.

FIG. 8 illustrates a code block for a device type definition for a unified design language that is in accordance with embodiments of the present invention.

FIG. 9 illustrates a conceptual block diagram of a two tiered device type definition framework comprising a unified device type upper tier that is in accordance with embodiments of the present invention.

FIG. 10 is a simplified schematic diagram of a computerized system for performing the functions of the compiler architecture shown in FIG. 3, in accordance with some embodiments.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers all such modifications and variations within the scope of the appended claims and their equivalents.

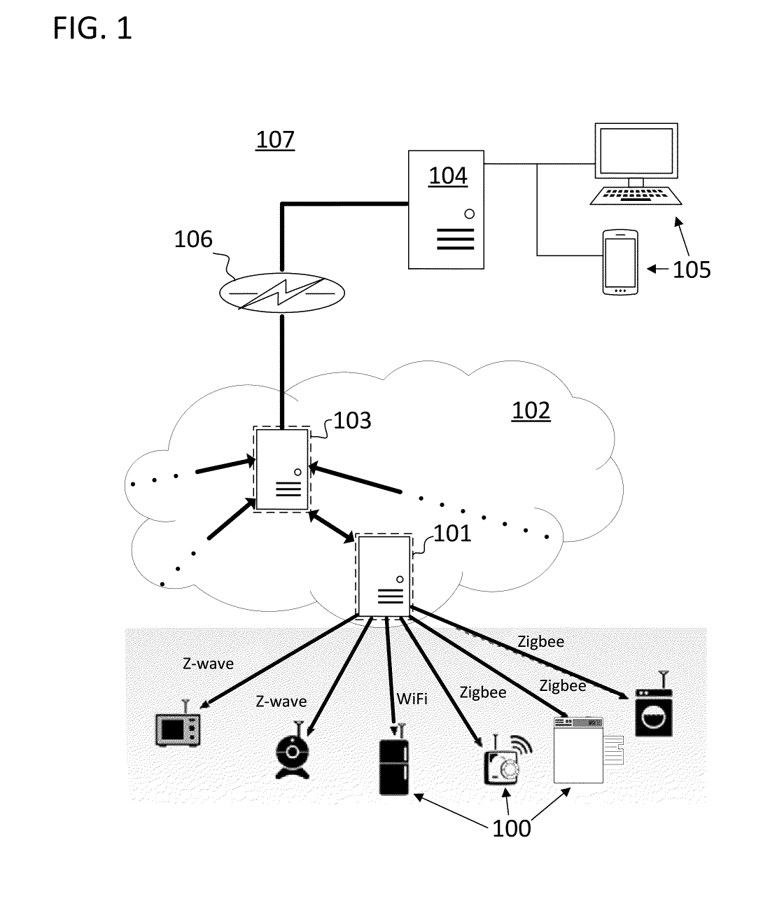

FIG. 1 illustrates an end-to-end IoT platform providing intelligent functionality to multiple end nodes 100 through one or more servers and/or user/client/access devices. As illustrated, end nodes 100 are devices, such as cameras, sensors, power outlets, and household appliances (among others), that are connected to a device server 101, which may be one or more physical computer devices or instantiated virtually in cloud 102. In some embodiments of the invention, end nodes 100 are intelligent virtualized devices such as those described in U.S. Pat. No. 8,392,561 which is incorporated by reference herein in its entirety. Device server 101 can be specifically configured to communicate with end nodes 100 according to a ubiquitous device design library as described in more detail below. Device server 101 is in communication with a web service platform server 103 which may also be one or more physical computer devices or instantiated virtually in cloud 102. The web service platform server 103 provides an operating system to host end nodes 100 and provide additional functionality to those nodes such as alerts, firmware updates, data services, and account management. The web service platform server 103 communicates with applications server 104.

Applications server 104, which may be one or more computer devices or instantiated virtually in a cloud, can provide for access to the operating system of web service platform server 103 for platform administrators, and can alternatively or cumulatively provide a portal for end nodes 100 via user/control/client/access devices (“access devices”) 105. In some approaches, the portal will be a web portal. As drawn, access devices 105 comprise a smartphone and a desktop computer. As such, access devices 105 in FIG. 1 are meant to illustrate the fact that the access devices 105 can provide connectivity to end nodes 100, e.g., via a web portal in a basic web browser running on any computer, or via an app on a smartphone specifically designed for that purpose. Access devices 105 can comprise any device capable of instantiating a web portal, and more generally can be any device capable of accessing the Internet. In some embodiments, the access device 105 is a computer that also serves as, or performs the functions of, some or all of the servers 101/103/104 to provide a more local or direct communication with, access to, and/or control of, the end node 100 by the access device 105 without having to communicate through a separate server. In some approaches, the applications server 104 communicates with the web service platform sever 103 via a unified web service application program interface (API) 106. The operation of unified web service API 106 is described in more detail below. Application server 104 could alternatively communicate directly with device server 101 via unified web service API 106, and the functionality of device server 101 and web service platform server 103 could be provided by a single server. Additionally, in some embodiments, the functionality of the device server 101, the web service platform server 103, and the application server 104 could be provided by a single server.

The architecture illustrated in FIG. 1 is a simplified version of an end-to-end IoT system. Additional servers, network nodes, and program interfaces may be included in a system that is in accordance with the teachings herein. For example, device server 101 could also communicated with the end nodes 100 via a gateway, which is not included in the diagram, as described in the U.S. Pat. No. 8,392,561. Furthermore, the end nodes 100 may communicate with device server 101 using any number of physical layer protocols including those of Zigbee, Z-wave, Wi-Fi, Ethernet, USB and others. Even in the simplified illustrated architecture, the design and testing challenges of the system are apparent. One of end nodes 100, for example, could be a simple lightbulb with an embedded controller and Wi-Fi radio that is meant to respond to a smartphone by turning on or off. The complete software package that needs to be deployed to model, design, implement, and test such a system would involve developing software for: the utility functionality of the embedded controller; communication functionality for the controller and the device server 101 (including packaging information regarding the state of the device via the Wi-Fi protocol); the web services platform; application server 104; and the user-facing application running on access device 105. To literally compound the design challenge, if the desired radio protocol of the device were changed from Wi-Fi to Zigbee, multiple nodes of the overall system might need to be redesigned. Although this complexity can be alleviated to some degree by keeping commands in a unified format all the way to device server 101, as possibly enabled by the API 106, a change in radio protocol will ultimately generally require some form of modification to the system.

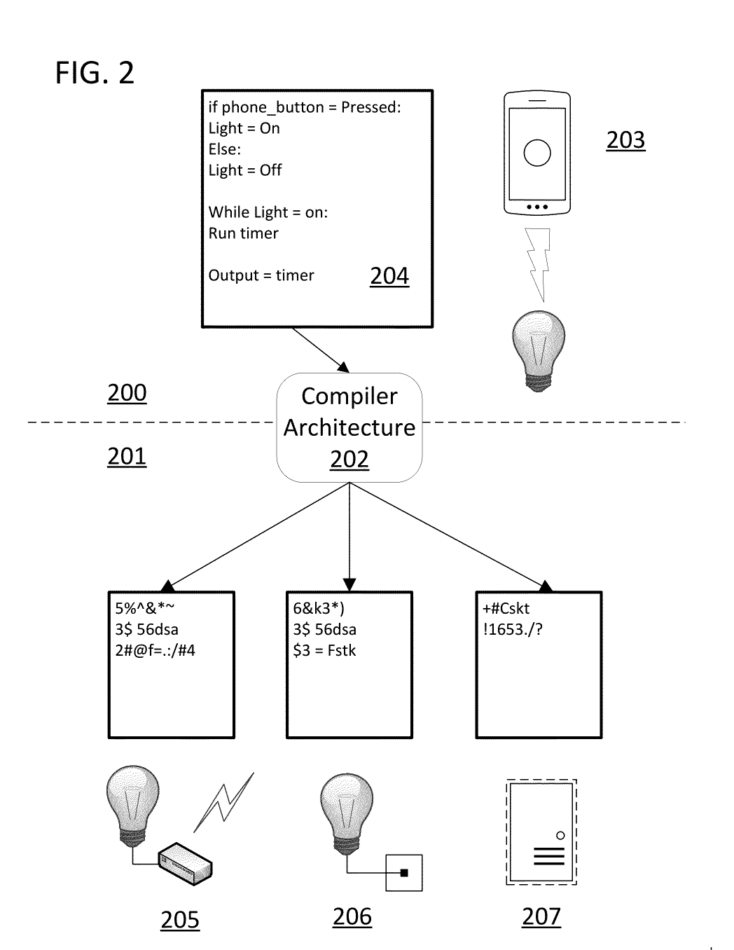

Designing for an IoT system, such as the one described with reference to FIG. 1, can be simplified via the application and utilization of a development framework that comprises a unified description of end nodes 100 and a compiler architecture that recognizes a clear separation between that unified description and the actual implementation of the system in the field. An IoT development framework developed by the assignee of the present application, that serves an example of this kind of framework, is referred to as LiveLi™. Aspects of such a framework can be described with reference to FIG. 2. FIG. 2 is separated into two conceptual segments, 200 and 201, which are each respectively above and below the dotted line that runs through compiler architecture 202 in the center of the diagram. This separation is meant to illustrate the partitioning of the design effort, afforded by the framework, between one that is solely directed to the desired user-to-end-node functionality of the system, and the actual implementation of that functionality on any given end-to-end IoT system.

The work that is done above the line for conceptual segment 200 is enabled by a specialized programming-language-neutral unified design language that takes on the myriad property, operational, and functional paradigms of all known and future IoT end devices by creating a design vocabulary for a unified description of their possible characteristics. This vocabulary allows for specificity in the definition of these end nodes, while at the same time it provides the flexibility to accommodate numerous potential end nodes which are known now or are yet to be developed. The LiveLi™ language developed by the assignee of the present application is one example of this kind of unified design language. In the illustrated example, a connected solution 203 is being designed in which a connected lightbulb will respond to an on/off switch on an access device, and will also keep track of how long the light has been turned on. As illustrated, a programming-language-neutral file 204 has been created that focuses specifically on the desired functionality, properties, and/or abilities of the connected solution. The programming-language-neutral file 204 is illustrated with pseudocode for explanatory purposes to illustrate the fact that the programming-language-neutral file 204 only needs to be directed to the desired functionality of the IoT system that is under development.

The work that is done below the line for conceptual segment 201 is automated as much as possible and is facilitated by certain aspects of the unified design language and by compiler architecture 202. The automated aspect of conceptual segment 201 is what shields the designers and developers from having to deal with the multiple communication protocols and code bases associated with an IoT system. After compiler architecture 202 has been configured for a particular IoT system and collection of protocols, it can automatically generate a collection of code files for the various nodes of the IoT system, and can do so in a way that matches any protocol by which that node may be communicating. For example, if the connected lightbulb were connected to the Internet via an embedded controller and Wi-Fi radio as in example 205, the compiler architecture would generate code to implement the functionality specified in section 200 to communicate efficiently over a Wi-Fi protocol. Alternatively, if the connected lightbulb were connected to the Internet via a hardwired Ethernet connection as in example 206, the compiler architecture would generate code to implement the functionality specified in section 200 to communicate using the Ethernet physical layer protocol. Once compiler architecture 202 is configured to support either type of IoT system, the same design effort would need to be expended to implement either end-to-end solution. In addition, code could be generated for each node in the network such as for the embedded device in examples 205 and 206, or for a server subsystem as illustrated by example 207. In short, by using the unified design language, programmers are able to write code in a simple and elegant framework and focus on the desired functionality of the system while another layer handles the actual implementation of the desired system in terms of the required radio protocols and web communication architecture.

The unified design language not only provides developers with the unique ability to describe IoT devices in a unified manner in conceptual segment 200, it's vocabulary and other characteristics are also meant to facilitate the automatic code generation that occurs in conceptual segment 201. There are two main characteristics of the unified design language that provide these benefits. First, the unified description of the end nodes can provide a canonical representation of the end nodes that is based on an object model. In these approaches, the canonical representations of the end nodes in the unified design language are designed to decompose into a neutral object model that facilitates code generation into any desired language by being both atomized and agnostic to those desired languages. Furthermore, the manner in which the neutral objects are created can be guided by a purpose adapter to aid the production of final code. The Neutron™ language developed by the assignee of the present application provides such a model. Secondly, the unified design language includes a ubiquitous device design library that includes predefined device models that can be used to model a desired IoT end node. The selection of device models for the design library is meant to provide a wide spread of possible end nodes that can be accurately modeled. More importantly, the device models are developed so that the model already “speaks” any number of communication protocols so that it is easier to decompose the model and generate the code required to implement its functionality in a given communications protocol. The CoCo™ device library developed by the assignee of the present application is an example of such a library.

As a specific example, in certain approaches, the ubiquitous device design library will include a set of device definitions that are specifically designed to speak various protocols such as ZigBee, Z-Wave, AC900, or any proprietary radio protocol or hardwire protocol. The contents of the design library are selected to provide maximum flexibility for potential devices that may be used with a desired IoT system. In addition, in specific approaches the devices specified in the ubiquitous device design library are specifically configured to operate with a unified web service API 106 such that simple service calls can be performed on representations of the devices in cloud 102. Using entries in the ubiquitous device design library, or additional entries that are developed from scratch using the unified device language, that “speak” a target protocol, compiler architecture 202 will produce code to enable a node in the IoT system to properly package those service calls for that specific targeted physical layer protocol. In one example, that code will be server code running on device server 101. Device sever 101 would thereby be enabled send the correct radio packets to and from the actual end node 100 to implement those service calls. As such, the device library provides a more fluid link between conceptual segment 200 and conceptual segment 201 as the ubiquitous device design device library provides a scaffolding for the translation of functionality in conceptual segment 200 into an implemented system in conceptual segment 201. In specific approaches, the ubiquitous device design library will augment abilities that are provided by the operating system of server 103 such as predefining the characteristics of a flow of data from the device.

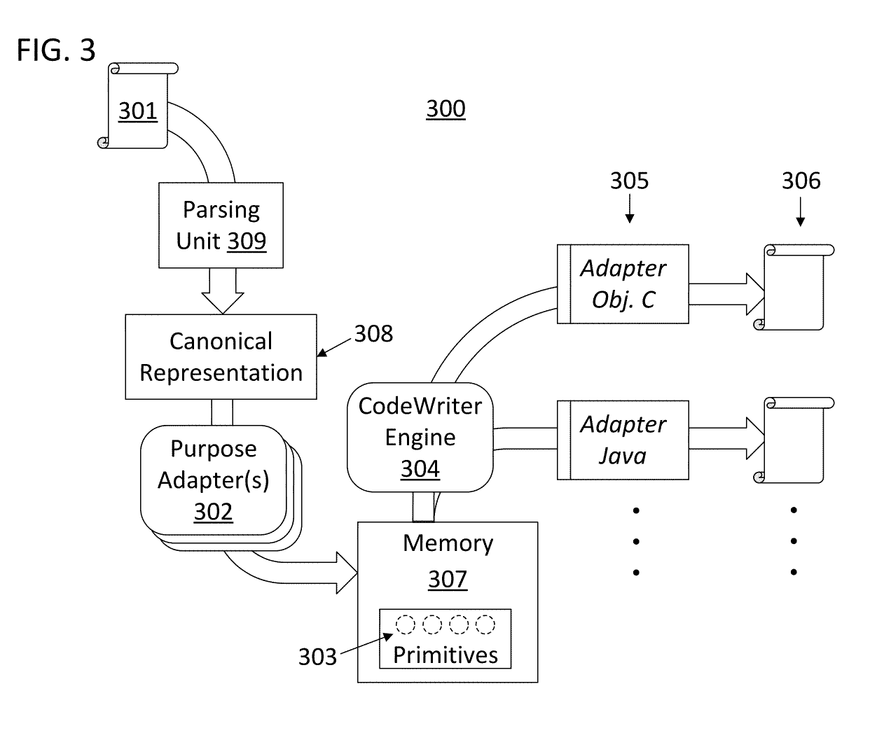

FIG. 3 illustrates a code generation compiler architecture 300 that facilitates the automated generation of code for an IoT system, such as IoT system 107, which includes the end nodes 100, the servers 101/103/104, and the access devices 105. Architecture 300 takes in an input language file 301 and generates code for the various nodes 100/101/103/104/105 of the IoT system 107. The input language file 301 is a programming-language-neutral file that describes (e.g., in a programming-language-independent code or a programming-language-dependent code used for a neutral purpose) an embedded device that is a specific-purpose end node 100 in an Internet-of-Things system 107. In some embodiments, the programming-language-neutral file is in a non-computer-executable code. In some embodiments, the architecture 300 parses the input language file 301 (e.g., by a parsing unit 309) to identify a canonical representation 308 of the end node 100, and decomposes the canonical representation 308 into primitives 303 (in a non-human-readable code) using at least one “purpose” adapter 302. The purpose adapters 302 are compilers that generate the primitives 303 with a special “purpose” that depends on, or relates to, the purpose of various desired output language files 306, which may serve any number of purposes. A non-exhaustive list of potential purposes for the output language files 306 include: (i) computer program code for run time client libraries for designing a user device application to be installed in the access devices 105; (ii) computer program server code for a server application to be installed in the application server 104; (iii) additional computer program server code for a web service platform application and a device communication application to be installed in the servers 103 and 101, respectively, including a server library for translating requests in the format of the web service API 106 into radio packets for a specific physical layer protocol; (iv) test scripts or computer program verification code for testing the IoT system 107; (v) computer program simulation code files for testing various portions, nodes or components of the IoT system 107; and (vii) computer program gateway code for a gateway application to be installed in a gateway between server 101 and the end nodes 100 of the IoT system 107. Hence, the purpose adaptors 302 serve different purposes specific to the design, testing, and implementation of various components of an overall IoT system 107.

At least one of the purpose adapters 302 generates a set of the primitives 303, which comprise an object model representation of at least part of the code in the input language file 301. The primitives 303 of the object model can be configured to be passed in one at a time to a code writer engine 304. In certain approaches, the primitives 303 represent an intermediate stage in the generating of the output language files 306 and are stored temporarily in a memory 307 to be fed into the code writer engine 304 in sequence, rather than being stored in a persistent memory, such as a hard drive. In some embodiments, memory 307 involves a database or disk storage, but in some embodiments memory 307 is a fast access random access electronic memory. The output language files 306 can be intended for any node 100/101/103/104/105 in the IoT system 107. In some embodiments, the output language files 306 are programming-language-specific files containing programming-language-dependent code and specifying a compilable-language computer program. In other words, the output language files 306 are specific to, or dependent on, a particular programming language code (e.g., Java, objective C, Pearl, C++, etc.) that can be compiled to form executable files for the applications to be installed in the appropriate nodes 100/101/103/104/105. In other embodiments, the output language files 306 represent the executable files for the applications to be installed in the appropriate nodes 100/101/103/104/105. In either case, examples may include programming-language-specific files for firmware or an embedded application to be installed into an embedded device or system (e.g., end node 100) for controlling the embedded device and communicating with the server 101, 103 or 104, various types of server applications for a virtualized device or web server (101/103/104) for communicating with and controlling the embedded device, or a user or client device application to be installed in the access devices 105 for communicating with and controlling the embedded device through a multi-protocol network. Alternatively, the output language files 306 can comprise scripts or verification code used to test the IoT system 107 in various ways or simulations of devices, components or nodes 100/101/103/104/105 in the IoT system 107.

Since the input language file 301 specifically defines or describes the embedded device that is a specific-purpose end node 100 (e.g., a physical device in some embodiments) in the IoT system 107, and since the output language files 306 are specifically provided for the nodes 100/101/103/104/105 (or specify the compilable or executable code for the nodes) in the IoT system 107, the input and output language files 301 and 306 are inextricably tied to computer technology. In particular, the sole purpose of the input and output language files 301 and 306 is necessarily linked to their use with a computer. Additionally, it is not possible or practical to generate the output language files 306 from the input language file 301 without the use of computer technology. Neither is it possible to use the resulting output language files 306 without computer technology. In other words, a human could not perform the functions of the code generation compiler architecture 300 (i.e., the functions of the parsing unit 309, the purpose adapters 302, the code writer engine 304, or target code adapters 305) or make use of the initial input language file 301, the resulting output language files 306, the intermediate-stage primitives 303 or the canonical representation 308 without a computer. In fact, the present invention enables a designer to create a single master description (the input language file 301) of an embedded device and automatically generate several different purpose output language files 306 therefrom to create the overall IoT system 107; whereas, a human tasked with designing the overall IoT system directly would not need to start with the single master description. Also, a human could not perform the functions of the nodes 100/101/103/104/105 or the applications installed therein that are generated from the output language files 306. Furthermore, the techniques described herein for using or generating the input and output language files 301 and 306 improve the function of the computer system used to process the input language file 301 and generate the output language files 306, since the overall computerized design process for creating the IoT system 107 is greatly improved, enhanced, simplified, streamlined, and made more efficient. Additionally, these techniques not only improve the technology or technical field of designing a system for communicating with, monitoring, and controlling various “things” (i.e., other than a general purpose computer) via the Internet (or other network), but also improve the various different technologies or technical fields for the devices (e.g., cameras, sensors, power outlets, household appliances, etc.) represented by each of the different types of end node 100. Furthermore, the technique described herein could not pre-empt the intended field of creating an IoT system, since other techniques for creating IoT systems already exist, so that the present invention is limited by the particular features described herein.

In some embodiments, the desired code for output language files 306 comprise: (i) a run time library for an access device 105, such as a client application running on the access device 105 and communicating with application server 104; and (ii) server code, such as for device server 101. In this approach, the input language file 301, written in the unified design language (e.g., a non-executable neutral-purpose code), is parsed by the parsing unit 309 to identify the canonical representation 308 of an end node that is to be controlled by or through a multi-protocol network. For example, the input language file 301 could be written in LiveLi™ and the end node 100 could be a virtualized connected light bulb that is to be controlled by a multi-protocol network represented by IoT system 107. At least one of the purpose adapters 302 could then generate the set of primitives 303 using the canonical representation 308 of the end node 100. The set of primitives 303 can comprise base components of an object model representation of at least part of the code in the input language file 301. For example, the object model could be a Neutron™ representation of various aspects of the connected light bulb. Once the code has been broken down into its base components, the primitives 303 can be operated on by a transformer (e.g., the code writer engine 304 working in combination with any number of target code adapters 305) to generate output language files 306. As illustrated, one target code adapter 305 could generate objective C code for a client node (e.g., one of the access devices 105), such that the first purpose adapter 302 was for generating a client run time library. To continue this example, a second one of the purpose adapters 302 could follow a similar procedure to generate server code for device server 101, such that the second purpose adapter 302 was for generating server code. As illustrated, the other target code adapter 305 could then be used in this situation to generate Java code for device server 101.

### Unified Design Language Specification

The unified design language that is utilized in conceptual segment 200 of FIG. 2 is focused on providing a specific yet flexible vocabulary for defining a set of potential end nodes that can meet the demands of any IoT device known now or yet to be developed while at the same time creating a more fluid link between the conceptual segments 200 and 201. In some embodiments, the unified design language includes terms defining properties and abilities of the end node 100 that depend on the type or function of the end node 100, as exemplified by the various constructs described below and in Appendix I. In certain approaches, the unified design language is also created to make the code easier to understand for someone that is evaluating the functionality of an IoT system. As such, the unified design language can be used by developers working exclusively in conceptual segment 200 as well as by system architects creating the links between conceptual segments 200 and 201 by defining libraries or generally facilitating the action of the purpose adapters, code writer engine, and transformer.

The grammar of the unified design language can be selected to specifically address certain design challenges and objectives that are particular to an IoT system. In a specific example, the unified design language employs standard strict JSON syntax and grammar with specific notations to accommodate the IoT design process. In certain approaches, the unified design language will utilize a grammar in which the notation <something1> is used, and where multiple “somethings” are enumerated as: <something2> . . . <somethingN>. In this grammar, the reference character N is utilized to show that the notation allows for any number of devices for the enumerated group. In certain approaches, the unified design language will utilize a grammar in which the notation “<somethingX>” essentially represents a replaceable variable where “something” describes what can be held by the enumerated construct. In certain approaches, the unified design language will utilize a grammar in which a question mark indicates that an element is optional. In certain approaches, the unified design language will utilize a grammar in which an arbitrary number of constructs can be utilized by the system. The notation for this concept can be “ . . . ”.

The object model of the unified design language could be based on a collection of data types, device types, device faces, and channels. The data types could comprise structured data for the object model. The device faces could comprise an interface description for the devices that could exist specifically in conceptual segment 200. The device types could describe an object model for the devices in the IoT system and could serve to span conceptual segments 200 and 201 in FIG. 2. The channels could comprise a description of the medium used to connect to devices.

In specific approaches, the unified design language could have a collection of data types similar to JSON. In specific approaches, the unified design language will have a larger set of primitives than JSON. In addition, the primitives could be quasi-primitives in that they could each comprise a field “units” that may be determined by a “set” or “get” command and a field “value” which might also be determined by a “set” or “get” command. For example, the unified design language could comprise the primitive types listed in Table I or any subset of those primitive types.

TABLE I
List of Unified Design Language Primitives

DeviceId
Boolean
Integer
Number
BigDecimal
Percent
String
Date
Time
DateTime
Price
Enum

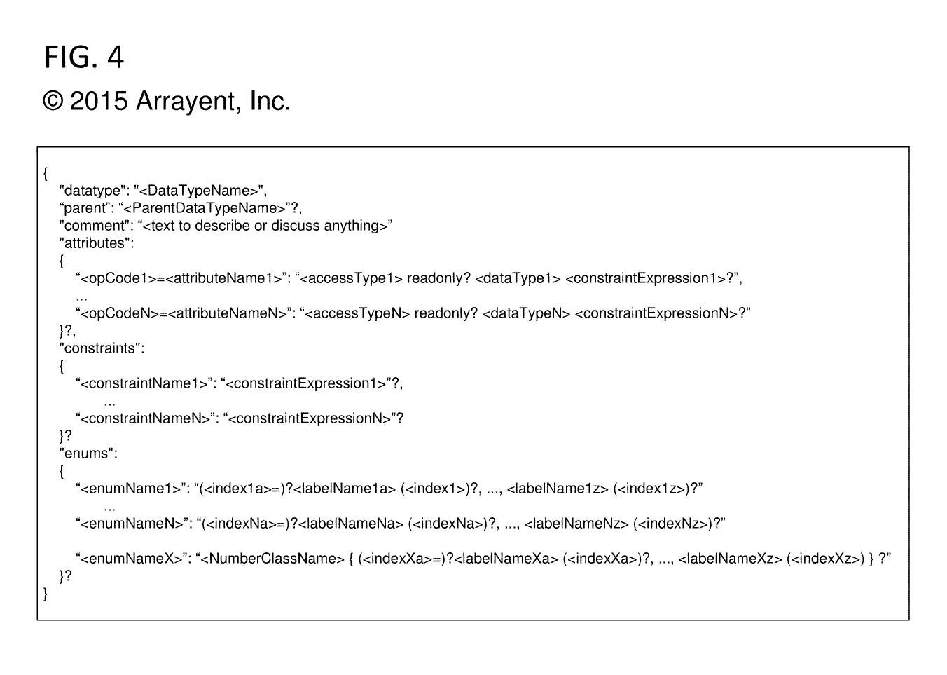

In specific approaches, the unified design language will exhibit a set of custom data types in addition to the primitive data types listed above. In specific approaches, a data type from the set of primitives above would be enumerated using the following notation: <dataTypeX>; where “dataType” was one of the primitive data types listed above or a custom data type. The code segment provided in FIG. 4 is an example of how a data type for the unified design language could be defined using a JSON syntax.

The code segment in FIG. 4 provides an illustration of several aspects of data types in the unified design language of these specific implementations including the data type grammar, access, and the ability to declare an enum with a number class for the storage of the enum. The data type grammar could include the notations: datatype, parent, attributes, constraints, enums, and comments. As to access, “readonly” means that an attribute may not be written to, while “accessType” is selected from one of the following choices: world, group, or private. World means that the attribute is accessible by any user having rights to the resources producing data with the attribute. Group means that the attribute is only accessible to users having rights to the device group producing data with the attribute. Private means that the attribute is only accessible to a single device to which the attribute is a part. The last enum declaration shown as <enumNameX> depicts the ability to declare an enum with a number class for storage. Unified design languages that include this aspect of the grammar exhibit a beneficial characteristic in terms of their utility for designing an IoT system in that the various radio protocol specifications require different size enumerations. When no number class for size is provided, the assumed default of 32-bit Integer is used. In specific approaches, the number class choices can include those listed in Table II.

TABLE II
List of Number Class Choices for Data Type Enum

Byte (8-bits)
UnsignedSmall (8-bits)
Short (16-bits)
UnsignedShort (16-bits)
UnsignedShortMid (24-bits)
Integer (32-bits)
Unsigned (32-bits)
UnsignedMid (48-bits)
Long (64-bits)
UnsignedLong (64-bits)

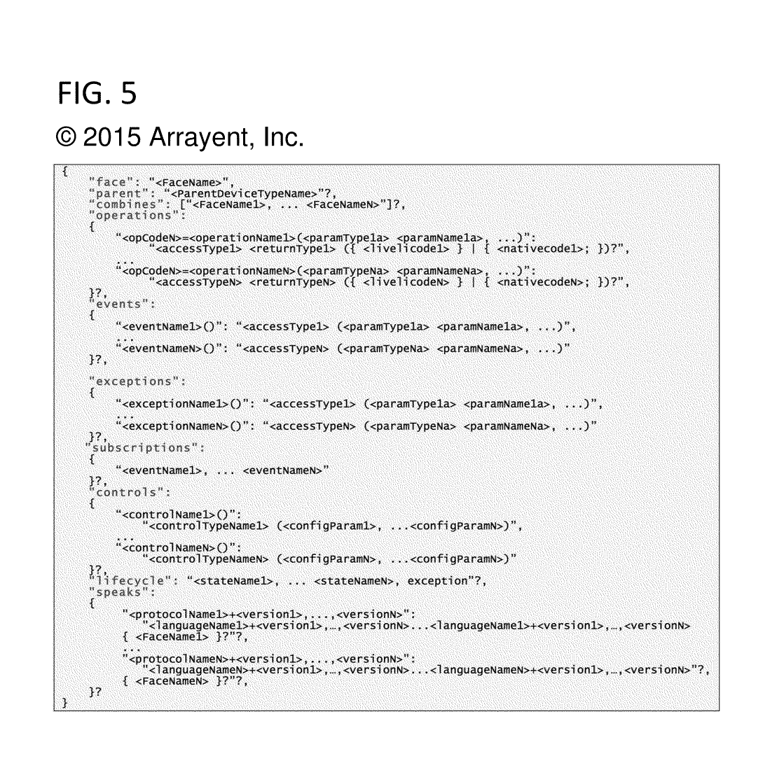

In specific approaches, the unified design language will include the ability to specify device faces that define the interface characteristics of an end node such as a device or a simulator. An example of a device face definition is provided in FIG. 5. The device face files could be in a parent director with distinct library subdirectories for various library implementations having device type files. For example, a subdirectory called “ZigBee” or “Bluetooth.” The design language face grammar could comprise the following declarations: +DataType, face, parent, combines, operations, events, exceptions, subscriptions, controls, lifecycle, and speaks. With reference to FIG. 5, note that enums can conveniently be defined in both the data type and device face definitions. Such definitions may even be repeated or different between other device face definitions. Where different, there will still only be one global enum and the union of all labels will be applied for the enum definition. Note the “(-)?” which means that a negative sign or dash in front of an operation name is optional. If included, it means that the operation is to throw a “not supported” exception at runtime. This may be necessary where, for example, a device type definition inherits or combines other device type definitions and technically, therefore, must implement all of the associated operations. In reality, real devices often are the inherited or combined result of many such device type definitions, but might not support one or a few of the specified operations.

The device face definitions can be supported by a set of inputs and outputs that are recognized elements of the design language. This aids the development of device face definitions by representing common interface elements for an IoT device. A list of inputs and outputs for a device face grammar of a unified design language are provided in Table III.

TABLE III
List of Inputs and Outputs for Device Face Grammar
© 2015 Arrayent, Inc.

Inputs:
Button
Switch(String aLabel1, String aLabel2)
TextInput (String aTypeConstraint, Integer aNumberOfCharsConstaint)
Dial (Integer aMinimum, Integer aMaximum, Integer anIncrement)
Slider (Integer aMinimum, Integer aMaximum, Integer anIncrement)
Selector (String aLabel1, String aLabel2, . . . , String aLabelN);
ColorSelector
Outputs:
TextDisplay (Integer aNumberOfCharsConstaint)
ColorDisplay
Graph (Integer aSecondsIncrement, String anAttributeName1)

In specific approaches, the “speaks” section labels the device face with speaking specific implementation protocols and versions. The label works in conjunction with the “manufacturer” clause to provide even finer granularity in the number of specific implementations that are supported by a given device face. If there is a “speaks” clause, then a particular device face will have multiple device types. At runtime, the specific device type implementation chosen will be based on the protocol and version necessary to be spoken as well as the manufacturer of the device.

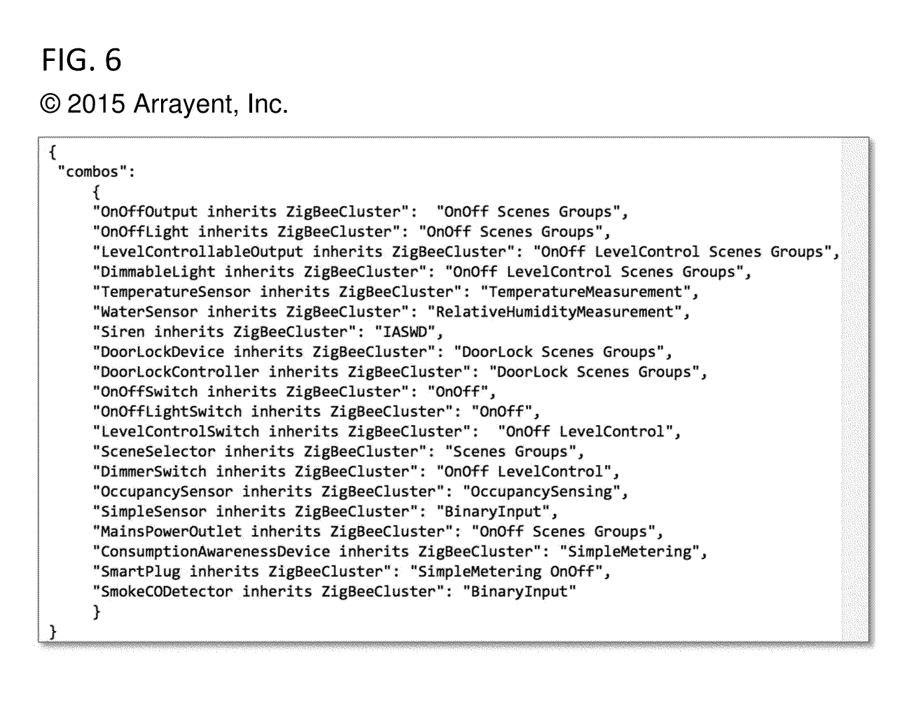

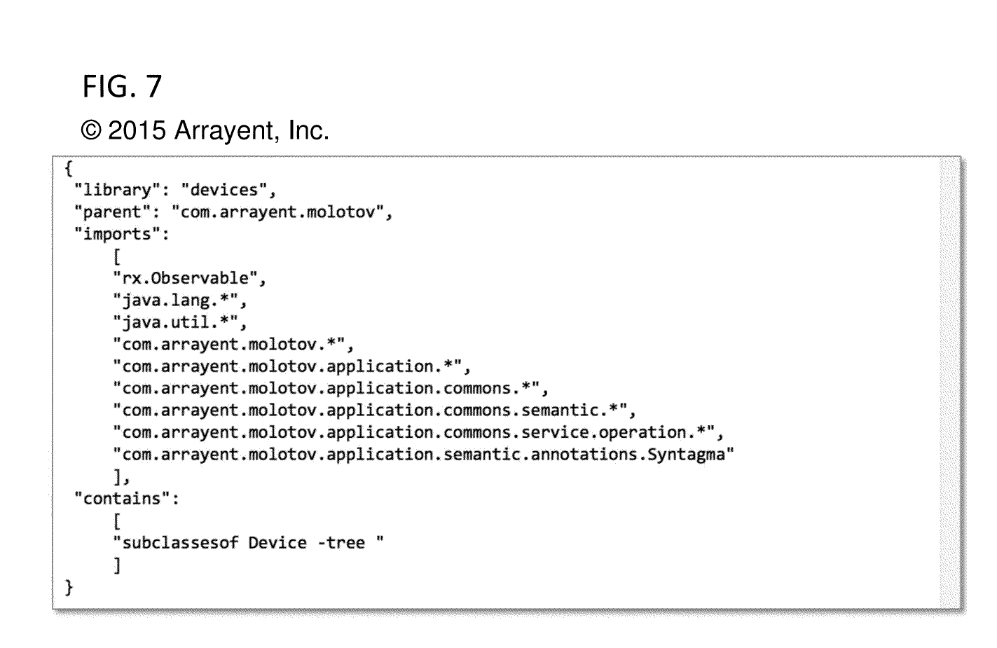

As mentioned previously, the unified design language can support combination devices and device libraries. The combination device face grammar can include a device name declaration, an optional “inherits” clause, and a list of faces. A sample list of combination definitions is provided in FIG. 6. The list illustrates how combination devices are specified by their device name, an optional list of the devices from which they inherit characteristics, and a list of device faces. The library grammar can include notation for a parent library, a list of imports, and a “contains” notation. Sample code for a library definition using the unified design language can be found in FIG. 7.

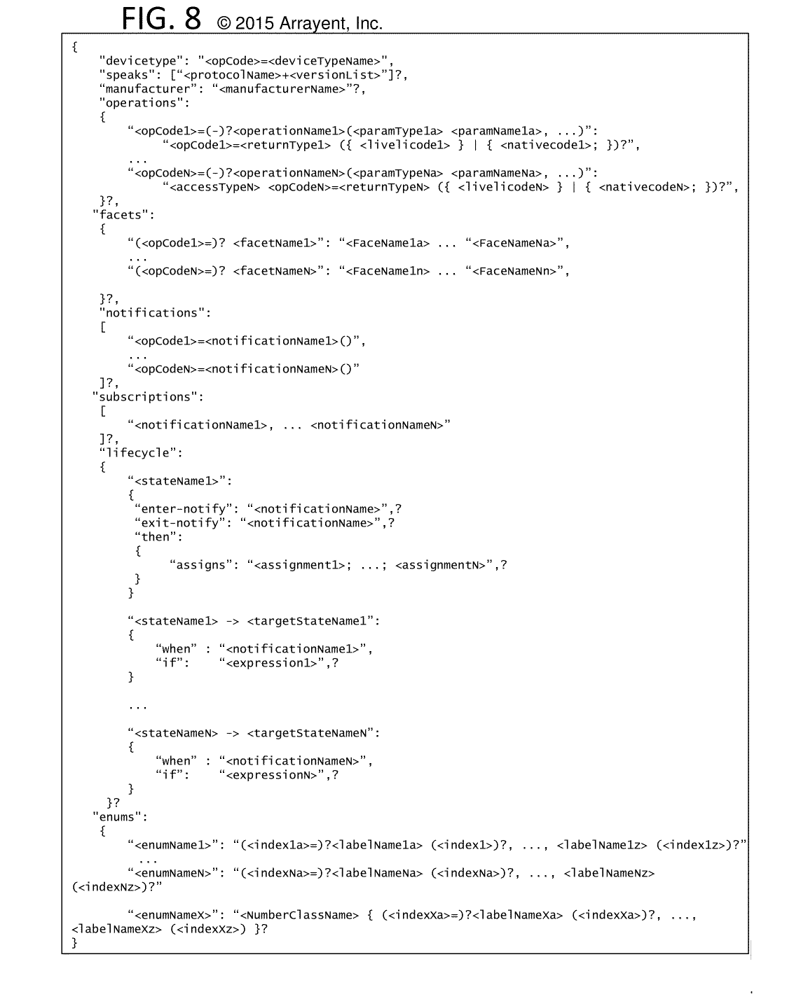

In specific approaches, the unified design language can comprise a specific grammar for a device type definition. An example of this type of grammar can be found in FIG. 8. The device type grammar is similar to the device face grammar. However, this code segment places particular emphasis on <opcodes>, lifecycle clauses, and “when” clauses. The <opcode> aspect of the grammar is described in more detail in the following paragraph. The lifecycle clause of the definition allows for implementing a lifecycle for the device which can be extremely advantageous when developing rules for the manner in which web service calls affect the device. The “when” clause is necessary to know what notification causes a transition to occur. When an “if” is present, the specified must be true as well to enter a target state. The “if”, “then”, and “notify” clauses are all optional. The “then” clause can specify modifications to the attributes of a device. Attributes may be updated by the device itself, but some attributes may be defined external to the device. Finally, the “notify” clause allows a lifecycle state to produce a notification.

In specific approaches a device type definition will include an <opcodes> notation. This notation relates to integer codes that are employed in radio packets for which the code can be generated by the compiler. The <opcodes> notation provides a particular example of how the unified design language provides a scaffolding for a frictionless transition between conceptual segments 200 and 201. In various radio protocol specifications, packet headers require static information that identify various aspects of the packet such as the function being requested or for which function the payload of the packet is intended. These packet headers often also identify a particular type of end node, as specified by the protocol specification, with which the packet is intended to operate. As such, <opcodes> alleviates an enormous burden on the compiler architecture 202 because the <opcodes> specifically link the definition of specific devices and operations as defined in the design language with those same characteristics as defined in a particular radio protocol. In addition, defining entries in the ubiquitous device design library using the device type grammar is facilitated by ready access to information on the content of the packet headers as provided by the publically available specifications for a given radio protocol. In this instance, what is more, future radio protocols not yet developed will very likely operate with a similar paradigm as to the information contained in their packets such that the design framework of the present disclosure will be able to accommodate them with little additional effort on the part of designers that are creating the link between conceptual segments 200 and 201 for the new protocols.

To further facilitate the translation of the unified design language into a target language, attribute mappings can be designed as part of the unified design language code file. Attributes can be translated for a specific adaptor by identifying the implementing variable name in the adapter and a map of its values to the adapted values. Note that in the following syntax, use of [ ] means mapping and that a colon is used to separate the target and source of the mapping: [<target1>:<source1>, . . . , target:<sourceN>]. The alternative notation: [*:*] can be used so that all source values map to the same value in the target for the remainder of the mapping. Cases for the attribute implementations are provided below in Table IV while Table V provides code examples for each case.

TABLE IV
List of Cases for Attribute Adaptor Implementation

Case 1: adaptor name change
Case 2: adaptor name change and mapping of all source values are the
same as the target values
Case 3: adaptor name change and mapping of some source values to
different target values and the rest are same source values to target values
Case 4: adaptor uses a different name for the value but the value also
needs to be transformed computationally

TABLE V
Code Examples for Cases in Table IV
© 2015 Arrayent, Inc.

Code 1: “count”: “{ quantity }”
Code 2: “currentLockState”: “{ LockState? [*:*] }”
Code 3: “currentDoorState”: “{ LockState? [Open:DoorOpen,
Closed:DoorClosed, Unknown:NotFullyClosed], *:* }”
Code 4: “percent”: “{ (level-100)/256 }”

Note that in addition to attributes, operations may have an implementation based on the unified design language code or a target code. When using unified design language code, the implementation will be simply described in terms of another operation. A beneficial aspect of the unified design language code is to have operation implementations in the unified design language that are capable of working with specific implementations of a specified device type that are similar. However, operation translations can also be specified using the unified design language code. Operation implementation cases are provided below in Table VI while Table VII provides code examples for each case.

TABLE VI
List of Cases for Operation Adapter Implementation

Case 1: adaptor method is exactly the same
Case 2: adaptor method and adapted method have no parameters but
adaptor method is different name
Case 3: adaptor method and adapted method have identical parameter
signatures but adaptor method is different name
Case 4: simple translation of unified Operation name to specific Operation
name as well as some parameter reordering.
Case 5: native code
Case 6: code can take on two or branches based on value of expression
Case 7: need to set an attribute and call an operation on adaptor
Case 8: simple translation of a parameter into whole or part of an
Operation name. In this case, the variable used for the Operation
name must be an enumeration.

TABLE VII
Code Examples for Cases in Table VI
© 2015 Arrayent, Inc.

Code 1: “turnOn( )” : “{ * }”
Code 2: “tumOn( )” : “{ on( ) }”
Code 3: “tumOn(*)” : “{ on(*) }”
Code 4: “turnOn(Color aColor)” : “{ send(Direction.On, $(Color)) }”
Code 5: “turnOn(Color aColor)” : “java{ StdColor= $(Color)*100/255;
return this.send(Direction.On, StdColor); }”
Code 6: ″lock(DoorSide aDoorSide)″: ″{ aDoorSide? [″Both″:
lockDoor( ), ~″Both″, error(aDoorSide+″ not supported″)] }″,
Code 7: “actuate(Direction aDirection)” : “{ direction=$(aDirection);
doCommand( ) }”
Code 8: “actuate(Direction aDirection)” : “{ $(aDirection)Command( ) }”

In specific approaches, device type definitions will declare only what the device itself implements such that it will be beneficial to provide functionality to add more specific device types by “adding” to them. An “add” will provide declaration of additional functionality that will be managed for a specific device type. As such, the add provides the ability for easy and simple declaration and management of auditing, statistics collection, external lifecycle, and external exceptions. In this context, “external” means that the lifecycle and additional exceptions are managed completely outside of the device implementation.

In specific approaches, the unified design language device types can include device types that are declared as “copycat,” wherein such a declaration implements a simulation of a device type. Simulations of a device type could be used for testing purposes. The copycat behavior is modeled primarily via its lifecycle definition. The implementation is similar to that presented in the device type definition but with extra declarations such as those that declare how long the device will wait for purposes of simulation. Lifecycles are the core definition of simulated behavior. There are two types of child declarations—just one state, and state transition. For each single state definition, a notify clause denotes any notification that should be generated anytime the state is entered or exited. The “then” clause can include an assigns and operates clause. Assigns allows additional assignments while operations allows modeling of calling operations multiple times. State transitions show the when and if required to make the transition happen. The “if” clause is optional. When two or more state transitions are identical with the same notification, then the probability of choosing one or the other is used from the associated probability declaration.

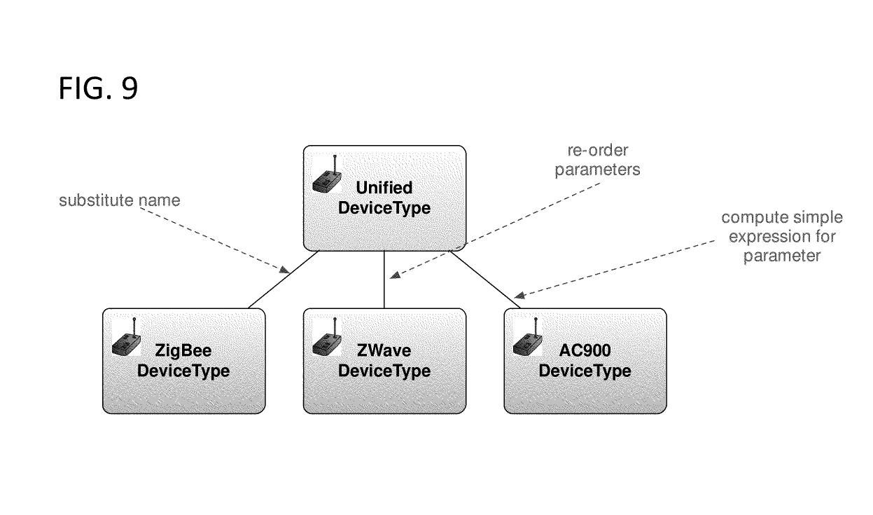

Device type unification is provided by breaking them into two layers. One of these layers is specific to the IoT functionality being designed for and one layer is specific to the implementation of the functionality in a given architecture. The first layer can be referred to as the unified face layer. The second layer will comprise device types for specific implementations such as for specific radio protocols. The “speaks” declaration provides information to control routing. As such, the first layer speaks multiple protocols and names the interface it uses when it is deployed on a channel that speaks one or the other languages while the second layer only speaks one protocol. A diagram of this breakdown is provided in FIG. 9.

### Neutral Object Model for Canonical Device Representation

As part of the compiler architecture described with reference to FIG. 2, the unified device modeling language can be temporarily translated into a unified neutral description of programming language constructs. These constructs are canonical to any target code base for which code will be generated to instantiate or test a desired IoT system. An example set of such constructs that can be converted into any specific desired target code language is provided below in Appendix I.

In specific approaches, the language will only have a binary representation as Java Objects in memory. Once the individual constructs are created, a Java code writer can be used to create the actual target code by operating on the constructs. The Java code writer could be a Java interface that can be adhered to a class having the name “<LanguageandPurpsosePhrase> codewriter” to generate a programming language file for a specific purpose. For example, the code writer could generate Junit testscripts for testing an IoT system such that the class name were: <JunitTesting>codewriter.

### Ubiquitous Device Design Library

As mentioned above, another advantage of the unified design language is its allowance for the development and usage of a ubiquitous device design library that includes predefined device models that can be used to model a desired IoT end node. The selection of device models for the design library is meant to provide a wide spread selection of end nodes that can be modeled with specificity. More importantly, the device models are developed so that the model already “speaks” any number of communication protocols so that it is easier to decompose the model and generate the code required to implement its functionality in a given communications protocol.

In specific implementations, the design library will be categorized into a set of entries that comprise devices, combo devices, and controllers. Within these categories, specific devices of note include user notifier devices, stream type devices, and datamart type devices. Datamart devices can be accessed by other devices to provide various forms of data that may be variable or constant. They are important for modeling IoT systems because one of the key differentiators of a connected device is its ability to access the wealth of information available on the Internet. Importantly, not all devices are actual physical end nodes in an IoT system. Indeed, major benefits are provided by treating information sources such as the time or weather as devices that output information for consumption by other devices in response to certain specified events. Controllers of note include group, scene, rule, schedule, and filter controllers. A scene is a specification for the state of a collection of devices such as “vacation” where devices in a house are switched into a low power mode while the owners of the home are away. Although some of these constructs are not typically considered separate entities in a system, beneficial results accrue to a design system that treats them as such by allowing designers to “pull in” an element, such as a rule, in the abstract instead of having to create a rule by defining the interactions of devices in their system.

Below is essentially a catalog of device types that serve as entries in an example ubiquitous device design library. The first list provides a list of devices, the second provides a list of combo devices, and the third list provides a list of controllers.

TABLE VIII
List of Devices

Light
Switch
DimmableLight
ColorLight
DoorLock
AdvancedDoorLock
OccupancySensor
SimpleMeter
Thermometer
RelativeHygrometer
AlarmZoneParticipant
SmokeSensor
Contact
Combo Devices

TABLE IX
Combo Devices

SmartPlug
ThermometerMotionCombo
ThermometerHygrometerCombo
NightRepeaterCombo
SmokeSensorAudioListener

TABLE X
List of Controllers

Controller
Gateway
Group
Scene

Each entry in the library can be specified in the unified design language using the device type or device face definitions or any other syntax provided above. The focus of each entry is the interactivity of the entry, and almost all interactions can be categorized into the following actions: get attribute, set attribute, and perform operation. Although each device type will have different attributes and operations, this semantic framework suffices for defining a large amount of possible interactivity. Each entry in the library can be augmented with specific attributes and operations that can be accessed through the web services API 106 in FIG. 1.

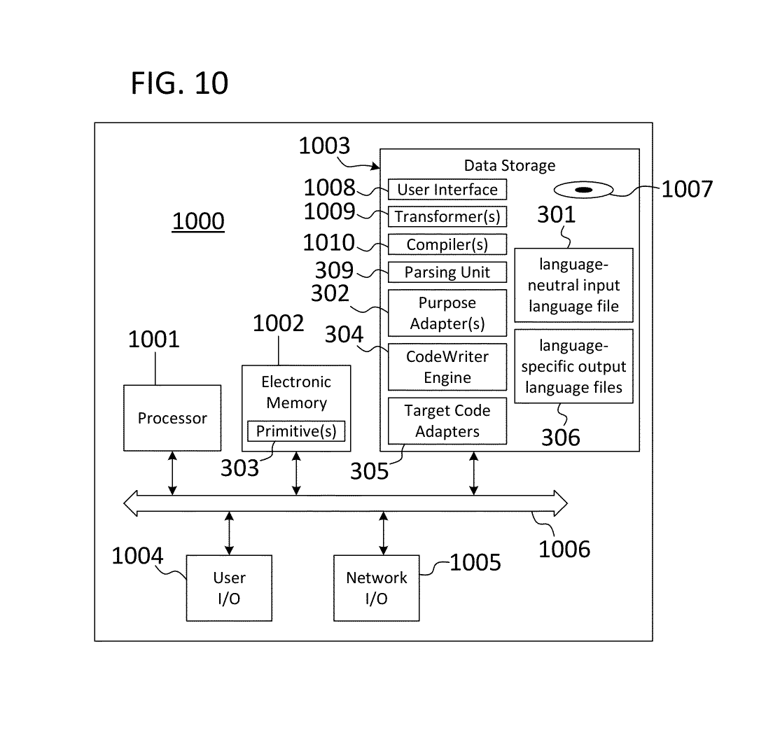

FIG. 10 shows an example computerized system 1000 for performing the functions of the code generation compiler architecture 300 to facilitate the automated generation of code (e.g., the output language files 306) to create the IoT system 107, in accordance with some embodiments. Other embodiments may use other components and combinations of components. For example, the computerized system 1000 may represent one or more physical computer devices, such as servers, workstations, desktop computers, notebook computers, rack-mounted computers, network storage devices, etc. In some embodiments implemented at least partially in a cloud network potentially with processing and/or data synchronized across multiple geolocations, the computerized system 1000 may be referred to as a cloud server. In some embodiments, the example computerized system 1000 generally includes at least one processor 1001, a main memory 1002, a persistent data storage 1003, a user I/O 1004, and a network I/O 1005, among other components not shown for simplicity, connected or coupled together by a data communication subsystem 1006.

The processor 1001 represents one or more central processing units on one or more PCBs in one or more housings or enclosures. The main memory 1002 represents one or more RAM modules, or fast access random access electronic memory, on one or more PCBs in one or more housings or enclosures. The data storage 1003 represents any appropriate number or combination of internal or external physical persistent mass storage devices, such as hard drives, optical drives, network-attached storage (NAS) devices, flash drives, etc. The user I/O 1004 represents one or more appropriate user interface devices, such as keyboards, pointing devices, displays, etc. The network I/O 1005 represents any appropriate networking devices, such as network adapters, etc. for communicating through the Internet, or other wide-area or local network, with other computerized systems. The data communication subsystem 1006 represents any appropriate communication hardware for connecting the other components in a single unit or in a distributed manner on one or more PCBs, within one or more housings or enclosures, within one or more rack assemblies, etc.

The data storage 1003 generally maintains (e.g., in a non-transitory computer readable medium 1007) the various programs and data used by the processor 1001 and the main memory 1002, as described above. For example, the programs generally include a user interface 1008, various transformers 1009 and compilers 1010, the parsing unit 309, the purpose adapters 302, the code writer engine 304, and the target code adapters 305, among other appropriate programs not shown for simplicity. Additionally, the data generally include the programming-language-neutral input language file 301 and one or more of the programming-language-specific output language files 306, among other appropriate data files.

Since the primitives 303 are produced only at an intermediate stage in the process to generate the output language files 306 from the input language file 301, there is no need to store the primitives 303 in persistent memory, in some embodiments. Therefore, the primitives 303 are shown in the main memory 1002, rather than in the data storage 1003.

In some embodiments, the programs and data in the data storage 1003 are loaded into the main memory 1002 and executed, processed or generated by the processor 1001 in various aspects of an overall computer-implemented method to generate the output language files 306 from the input language file 301, as described above, in order to be able to create and test the elements of the IoT system 107. In doing so, in some embodiments, the computerized system 1000 becomes a special-purpose computer for performing this method. Additionally, in some embodiments, the programs in the data storage 1003 represent executable instructions stored on or in the non-transitory computer readable medium 1007 that enable the processor 1001, acting in combination with the electronic memory 1002, to execute the computer-implemented method.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

### APPENDIX I

### Canonical Constructs for Object Model

Core Constructs

| Construct Type | Description |
|---|---|
| MainConstruct | Superclass of all constructs. |
| | It maintains the following attributes: |
| | comment |
| | module |
| | name |
| | parentName |
| | accessName (public, protected, private) |
| | annotation |
| | codeblock |
| | methodType |
| | opcode |
| ModuleConstruct | Module represents a group of constructs that work together and/or provide service a |
| | larger cooperating unit. For example, it often represents a library of many classes |
| | and interfaces. Different languages call this Module by different names. |
| | In addition to inheriting what is in MainConstruct, it comprises: |
| | name |
| | List of InterfaceConstructs |
| | List of ClassConstructs |
| | List of imports |
| InterfaceConstruct | In addition to inheriting what is in MainConstruct, it comprises: |
| | List of InterfaceConstructs |
| | List of MethodConstructs |
| | List of VariableConstructs for instance Variables |
| | List of imports |
| ClassConstruct | Represents state and executable code for objects that are of the Class's Type. |
| | In addition to inheriting what is in InterfaceConstruct, it comprises: |
| | List of VariableConstructs for static or Class Variables |
| EnumConstruct | In addition to inheriting what is in MainConstruct, it comprises: |
| | Map of names to Integers |
| | highestIndex, or Integer in the Map |
| | storageClassName (name of a ClassConstruct) |
| VariableConstruct | In addition to inheriting what is in MainConstruct, it comprises: |
| | InterfaceConstruct it belongs to (wherein this can be a ClassConstruct it |
| | belongs to) |
| | isClassScope boolean |
| | isFinal boolean |
| | methodConstruct if it belongs to a method |
| MethodConstruct | In addition to inheriting what is in MainConstruct, it comprises: |
| | InterfaceConstruct it belongs to (wherein this can be a ClassConstruct it |
| | belongs to) |
| | isClassMethod boolean |
| | signature which is a List of ParameterConstructs |
| | exception Names, that can be thrown |
| | isFinal boolean |
| | Note that signature includes a ParameterConstruct representing one or more |
| | outputs or return values. |
| | Also, the protected method sortParametersIntoInAndOutLists( ) |
| | produces: |
| | inputParameters as List of ParameterConstructs |
| | outputParameters as List of ParameterConstructs |
| | returnTypeName if there is only one output Parameter |
| ParameterConstruct | In addition to inheriting what is in MainConstruct, it comprises: |
| | methodConstruct, it belongs to |
| | direction (in, out, inout) |
| | typeName |
| | It uses name from the inherited MainConstruct for the name of the Parameter |
| AliasConstruct | In addition to inheriting what is in MainConstruct, it comprises: |
| | kindName, which is one of a context name. For example, Class, Library, |
| | Method, Variable. |
| | It uses inherited name for the alias class name and |
| | It uses inherited parentName for the existing class name. |
| AnnotationConstruct | In addition to inheriting what is in MainConstruct, it comprises: |
| | typeName, for the type of Annotation |
| | Map of Parameter Names to replacement values |
| | List of Parameter Names representing their order |
| EventConstruct | In addition to inheriting what is in MainConstruct, it comprises: |
| | typeName, for the type of Event |
| | parameters, which is a List of ParameterConstructs, that contain |
| | information about the Event when it occurs. |
| | This represents a callback that the Class is able to perform so that it can notify |
| | clients asynchronously. |

Codeblock Constructs

| Construct Type | Description |
|---|---|
| Codeblock | Superclass of all Codeblock Constructs. |
| | It is able to represent 1 or more other Codeblocks. It maintains one instance |
| | variable: |
| | codeblocks, which is a List of Codeblock |
| AssignmentBlock | It comprises: |
| | variableName |
| | typeName |
| | which is assumed to be assigned by one Codeblock in the inherited codeblocks |
| | variable. |
| ChainedDotOperatorsBlock | This class inherits Codeblock and makes the assumption that each Codeblock in |
| | codeblocks is represented in order with dot operator in between each |
| | Codeblock. |
| ExpressionBlock | This class comprises: |
| | expression as a String |
| | variableReplacementCodeblocksMap which is Map of names to |
| | Codeblocks |
| | It is expected that $(aVariableName) or # aVariableName # is used in the |
| | expression and that each is replaced with the Codeblock given for that name. |
| ConditionalLoopBlock | This class comprises: |
| | expressionBlock, that represents the condition to continue the loop |
| | loopType, is either While or Do which represents whether the |
| | condition (expressionBlock) is checked at start or end of loop. |
| | The inherited codeblocks represents the code to perform in the loop. |
| ConstructBlock | The class comprises: |
| | className, representing the name of the class to create |
| | The inherited codeblocks represents 1 or more parameters as executable |
| | codeblocks for the constructor parameters for the class. |
| IfThenBlock | Class IfThenBlock represents an If-elseif-else block with arbitrary quantity of |
| | elseif's in between. A List of ExpressionBlocks are added and for each one, |
| | there must be a Codeblock added to the inherited Codeblock via add( ). This |
| | class also designates whether an expression-less or “empty” else clause trails |
| | the statement. |
| | It comprises: |
| | expressionBlocks to maintain the order of expression/conditions to |
| | check beginning with if, then else-if's, followed by an optional else. |
| ImmediateValue | It comprises: |
| | value, which is any Object |
| IncrementBlock | It comprises: |
| | increment, the amount to increment each time |
| | variableName, which must be a Number |
| MethodInvocationBlock | It comprises: |
| | callerCodeblock, an executable Codeblock that must resolve to a |
| | calling object |
| | methodName, which is the name of the method to call |
| | It uses the inherited codeblocks to store Codeblocks to resolve parameters for |
| | the method being to call. Each Codeblock is a parameter to use in the method |
| | call in the same order. |
| ObjectNameBlock | It comprises: |
| | name, representing the name of an Object (a variable name) |
| ReturnBlock | This class simply employs one Codeblock in the inherited codeblocks to |
| | represent the code to execute, or name of an object to return. |

What is claimed is:

1. A method comprising:
receiving, by a processor acting in combination with an electronic memory, a programming-language-neutral file that describes an embedded device that is a specific-purpose end node in an Internet-of-Things system; and
generating, by the processor from the programming-language-neutral file, a programming-language-specific file for a node in the Internet-of-Things system, the programming-language-specific file being in a programming-language-dependent code and specifying a compilable-language program for a control application to be installed in a computer in the Internet-of-Things system for communicating with and controlling the embedded device.

2. The method of claim 1, further comprising:
generating, by the processor from the programming-language-neutral file, a second programming-language-specific file specifying a second compilable-language program for an embedded application to be installed in the embedded device for controlling the embedded device and communicating with the computer.

3. The method of claim 1, further comprising:
generating, by the processor from the programming-language-neutral file, a second programming-language-specific file for a second node in the Internet-of-Things system, the second programming-language-specific file being in a second programming-language-dependent code and specifying a second compilable-language program for at least one purpose of: 1) a user device application to be installed in an access device for communicating with and controlling the embedded device through a multi-protocol network, 2) an embedded application to be installed in the embedded device for controlling the embedded device and communicating through the multi-protocol network, 3) a simulation application for performing a simulation to analyze performance of the embedded device, 4) a verification application for testing the embedded device, and 5) a gateway application to be installed in a gateway between the computer and the embedded device.

4. The method of claim 3, wherein the second programming-language-specific file represents a run time client library code for multiple user device applications to be installed in multiple access devices for communicating with and controlling the embedded device.

5. The method of claim 1, wherein the generating further comprises:
parsing the programming-language-neutral file to identify a canonical representation of the embedded device; and
using the canonical representation to generate the programming-language-specific file.

6. The method of claim 1, wherein the generating further comprises:
temporarily generating a set of primitives in the electronic memory using a purpose adapter applied to the programming-language-neutral file; and
using the set of primitives to generate the programming-language-specific file.

7. The method of claim 1, wherein the programming-language-neutral file is in a non-computer-executable code.

8. The method of claim 1, wherein the programming-language-dependent code is a computer-executable code.

9. The method of claim 1, wherein the computer and the embedded device communicate through a multi-protocol network.

10. The method of claim 1, wherein the computer is at least one of:
an application server that provides a portal for a user device application installed in an access device;
a web service platform server that provides to nodes in the Internet-of-Things system at least one of: alerts, firmware updates, data services, and account management; and
a device server that communicates with the specific-purpose end node.

11. The method of claim 1, wherein the computer is a user access device that communicates with the embedded device without communicating through a server.

12. The method of claim 1, wherein the programming-language-neutral file specifies properties and abilities of the embedded device.

13. The method of claim 1, wherein the specific-purpose end node is a physical electronic device.

14. A method comprising:
receiving, by a processor acting in combination with an electronic memory, a programming-language-neutral file that describes an embedded device that is a specific-purpose end node in an Internet-of-Things system; and
converting, by the processor, the programming-language-neutral file into at least one programming-language-specific file for at least one node in the Internet-of-Things system, the at least one programming-language-specific file being in at least one programming-language-dependent code and specifying at least one compilable-language program for at least one purpose of: a) a server application to be installed in a server in the Internet-of-Things system for communicating with and controlling the embedded device through a multi-protocol network, b) a user device application to be installed in an access device for communicating with and controlling the embedded device through the multi-protocol network, c) an embedded application to be installed in the embedded device for controlling the embedded device and communicating through the multi-protocol network, d) a simulation application for performing a simulation to analyze performance of the embedded device, e) a verification application for testing the embedded device, and f) a gateway application to be installed in a gateway between the server and the embedded device.

15. The method of claim 14, wherein the converting further comprises:
converting, by the processor, the programming-language-neutral file into at least two programming-language-specific files for at least two nodes in the Internet-of-Things system, the at least two programming-language-specific files specifying at least two compilable-language programs for at least two purposes of: a-f.

16. A non-transitory computer readable medium comprising executable instructions stored thereon enabling a processor, acting in combination with an electronic memory, to execute a computer-implemented method, the computer-implemented method comprising:
receiving a programming-language-neutral file that describes an embedded device that is a specific-purpose end node in an Internet-of-Things system; and
converting the programming-language-neutral file into a programming-language-specific file for a node in the Internet-of-Things system, the programming-language-specific file being in a programming-language-dependent code and specifying a compilable-language program for a control application to be installed in a computer in the Internet-of-Things system for communicating with and controlling the embedded device.

17. The non-transitory computer readable medium of claim 16, wherein the computer-implemented method further comprises:
generating, from the programming-language-neutral file, a second programming-language-specific file specifying a second compilable-language program for an embedded application to be installed in the embedded device for controlling the embedded device and communicating with the computer.

18. The non-transitory computer readable medium of claim 16, wherein the computer-implemented method further comprises:
generating, by the processor from the programming-language-neutral file, a second programming-language-specific file for a second node in the Internet-of-Things system, the second programming-language-specific file being in a second programming-language-dependent code and specifying a second compilable-language program for at least one purpose of: 1) a user device application to be installed in an access device for communicating with and controlling the embedded device through a multi-protocol network, 2) an embedded application to be installed in the embedded device for controlling the embedded device and communicating through the multi-protocol network, 3) a simulation application for performing a simulation to analyze performance of the embedded device, 4) a verification application for testing the embedded device, and 5) a gateway application to be installed in a gateway between the computer and the embedded device.

19. The non-transitory computer readable medium of claim 16, wherein the generating step of the computer-implemented method further comprises:
parsing the programming-language-neutral file to identify a canonical representation of the embedded device; and
using the canonical representation to generate the programming-language-specific file.

20. The non-transitory computer readable medium of claim 16, wherein the generating step of the computer-implemented method further comprises:
temporarily generating a set of primitives in the electronic memory using a purpose adapter applied to the programming-language-neutral file; and
using the set of primitives to generate the programming-language-specific file.
